(19) United States
(12) Patent Application Publication
(10) Pub. No.: US 2001/0013992 A1
(43) Pub. Date: Aug. 16, 2001

(54) Thin film magnetic head with tip sub-magnetic pole and method of manufacturing the same

(75) Inventors: Ikuya Tagawa, Kawasaki (JP); Syuji Nishida, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 09/802,390

(22) Filed: Mar. 9, 2001

Related U.S. Application Data
(63) Continuation of application No. PCT/JP99/00738, filed on Feb. 19, 1999.

(30) Foreign Application Priority Data
Sep. 18, 1998 (JP) 10-264726

(51) Int. Cl. G11B 5/31

(52) U.S. Cl. 360/126

(57) ABSTRACT

A thin film magnetic head includes: a lower magnetic pole (8); an upper magnetic pole (16) disposed to face the lower magnetic pole; a recording coil disposed between the lower magnetic pole and the upper magnetic pole, the recording coil being spaced from the both magnetic poles; and an upper tip sub-magnetic pole (22) provided at the side of the lower magnetic pole of the upper magnetic pole in the vicinity of a floating surface (ABS). The upper tip sub-magnetic pole (22) is formed in such a manner that a core width (SW2) of a body portion thereof is larger than a core width (SW1) at the floating surface (ABS). When a position where the core width of the tip sub-magnetic pole (22) starts to spread is defined as a tip projection height (SH), the tip projection height is selected to be 0.3 μm or more; when a difference between the core width (SW2) of the body portion and the core width (SW1) on the floating surface is defined as a spread (Δ SW) of a core width of a tip sub-magnetic pole, the spread of the core width is selected to be 3.2 μm or less; and when a film thickness of the upper tip sub-magnetic pole (22) is defined as a length (SL) of a tip sub-magnetic pole, the length of the tip sub-magnetic pole is selected to be 3.6 μm or less. The thin film magnetic head with the tip sub-magnetic pole having such a structure can exhibit a good overwrite characteristic and a good recording blur characteristic.

### TECHNICAL FIELD

The present invention relates to a thin film magnetic head for use in a magnetic disk drive, a magnetic tape apparatus or the like, more specifically to a thin film magnetic head with a tip sub-magnetic pole having a unique shape, and a method of manufacturing the same.

### BACKGROUND ART

As magnetic heads for use in a magnetic disk drive, a magnetic tape apparatus or the like, there are known an inductive recording/reproducing thin film head, a complex magnetic head using an inductive recording head and a reproducing head using a magnetoresistance effect element, or the like.

FIG. 1 is a view showing a constitution of a typical complex magnetic head with a portion thereof being cut out. In order to make it easy to see the inside of the magnetic head, illustration for a protective layer of the uppermost layer is omitted, and with regard to a recording head WR, the right half thereof is removed.

The illustrated complex magnetic head comprises: a semiconductor substrate (wafer) 1; a substrate protective film 2 formed on this substrate 1; a reproducing head RE formed on the substrate protective film 2; the recording head WR formed on the reproducing head RE; and the protective layer 17 (not shown) formed on the recording head WR.

The reproducing head RE includes: a lower magnetic shield layer 3; a first non-magnetic insulating layer (lower gap layer) formed on the lower magnetic shield layer 3; a magnetic transducer 5 formed on the first non-magnetic insulating layer 4; a pair of terminals 6 (only one terminal being shown in the illustrated example) formed at both ends of the magnetic transducer 5; a second non-magnetic insulating layer (upper gap layer) 7 formed on the magnetic transducer 5 and the pair of terminals 6; and an upper magnetic shield layer 8 formed on the second non-magnetic insulating layer. The upper magnetic shield layer 8 is combined with a lower magnetic pole of the recording head WR.

The recording head WR includes: the lower magnetic pole 8; a recording gap layer 9; a spiral recording coil 12 disposed on the recording gap layer 9; third and fourth non-magnetic insulating layers 10 and 11 covering the recording coil 12; and an upper magnetic pole 16 formed on the non-magnetic insulating layers 10 and 11. Note that the recording coil does not exist in a center region 13 of the spiral recording coil 12, and the upper magnetic pole 16 dents in the center region 13 to be connected to the lower magnetic pole 8. In addition, the upper magnetic pole 16 tapers toward a recording medium 20, and this portion is particularly called a pole 16a of the upper magnetic pole.

As described above, the complex magnetic head shown in FIG. 1 has a piggyback structure in which the recording head WR is added to a back of the reproducing head RE. Note that, in order to clarify a positional relation among the respective elements of the magnetic head, as shown in the drawing, the direction of a floating surface of the upper magnetic pole 16 is defined as an X direction, the depth direction of the magnetic head when viewed from the floating surface is defined as a Y direction, and the laminating direction of the magnetic head is defined as a Z direction.

Moreover, as the magnetic transducer 5 of the reproducing head RE, for example, an anisotropic magnetoresistance effect element (MR element), typically, a giant magnetoresistance effect element (GMR element) such as a spin-valve magnetoresistance effect element or the like can be used. To both ends of the magnetic transducer 5, the pair of terminals 6 are connected, and during a reading operation, a constant sense current is flown through the terminals 6 to the magnetic transducer 5.

As described above, the complex magnetic head faces the recording medium 20 such as a magnetic disk separately by a slight distance (flying amount) to be positioned, reads out magnetically recorded information recorded in the recording medium 20 by the reproducing head RE, and magnetically writes information to the recording medium 20 by the recording head WR, while moving relatively to the recording medium 20 along a track longitudinal direction (bit length direction).

FIG. 2A and FIG. 2B are views explaining the recording head WR in the complex magnetic head of FIG. 1 in more detail.

As shown in FIG. 2B, the recording head has a structure in which the two magnetic poles (lower magnetic pole 8 and upper magnetic pole 16) face each other by interposing the small recording gap layer 9. The lower magnetic pole 8 is called a leading side magnetic pole because it becomes a magnetic pole encountering a track on the recording medium 20 for the first time from the running direction of the recording medium 20, and on the other hand, the upper magnetic pole 16 is called a trailing side magnetic pole because it becomes a magnetic pole in a direction where the track on the recording medium 20 fades away. Between the lower magnetic pole 8 and the upper magnetic pole 16, there exists a spiral recording coil 12 surrounded by the non-magnetic insulating layers 10 and 11.

In the recording head WR, when current is flown to the recording coil 12, the upper magnetic pole 16 and the lower magnetic pole 8 are magnetized, a recording magnetic field (leakage magnetic field) for writing to the recording medium 20 is generated at a pole 16a side of the upper magnetic pole 16 and a floating surface (ABS: Air Bearing Surface) side of the lower magnetic pole 8, which are on both sides of the recording gap layer 9. In the recording head WR, the recording medium 20 is magnetized by this leakage magnetic field, and information recording is performed.

It is conceived that a magnetic field intensity H, the magnetic field being applied to the recording medium 20, is appropriate at about twice a medium coercive force Hc, and since the coercive force He of a recent recording medium is nearly 3000 [Oe: oersted], it is desirable that the magnetic field intensity H during recording be about 6000 [Oe].

Moreover, the magnetic field intensity H of a lower limit where a reverse of magnetization occurs in the recording medium 20 is generally conceived to be about ½ (namely,, 1500 [Oe]) of the medium coercive force Hc. Accordingly, when there exists a magnetic field exceeding ½ of the medium coercive force Hc outside a range of the track to be recorded thereon, reverse of magnetization (recording blur) is generated in a track adjacent to the track concerned, and the reverse of magnetization (recording demagnetization) at a trailing side in the head running direction occurs, thus bringing a barrier for high recording densification of the recording medium.

In order to realize the high recording densification, usually, it is necessary to increase a track density. For this purpose, it is necessary to narrow a width of the recording magnetic field to be generated by narrowing a core width at an end portion of the pole 16a of the upper magnetic pole and a core width at an end portion of the lower magnetic pole 8. In the above-described complex magnetic head, since the lower magnetic pole 8 of the recording head WR is combined with the upper magnetic shield layer 8 of the reproducing head RE, there is a certain limitation on a shape of the complex magnetic head from the viewpoint of securing a function of the magnetic shield. Specifically, the lower magnetic pole 8 has been formed to have a core width considerably wider than the core width of the upper magnetic pole 16 from the need of sharing the function of the magnetic shield therewith. For this reason, the recording magnetic field formed between both of the magnetic poles 8 and 16 has been distributed widely in the track width direction, and it has been difficult to narrow a track pitch of the recording medium 20 in the wide recording magnetic field.

As an example of the art to cope with this, for example, the art disclosed in the gazette of Japanese Patent Laid-Open No. 7-225917 (corresponding U.S. patent application No. 192680) is known. In this art, a lower magnetic pole end element and an upper magnetic pole end element (each magnetic pole end element is also referred to as a “tip sub-magnetic pole”), each of which has a narrow core width, are additionally formed for the lower magnetic pole 8 and the upper magnetic pole 16, respectively, thus reducing the recording blur in the core width direction.

FIG. 3A and FIG. 3B show a constitution of a thin film magnetic head with the tip sub-magnetic poles according to the prior art. FIG. 3A is a view corresponding to FIG. 2B, and FIG. 3B is a view of the respective magnetic pole sides viewed from the floating surface ABS. As shown in FIG. 3A, the lower magnetic end element (lower tip sub-magnetic pole) 21 is formed at the upper magnetic pole 16 side of the lower magnetic pole 8 in the vicinity of the floating surface ABS, and the upper magnetic pole end element (upper tip sub-magnetic pole) is formed at the lower magnetic pole 8 side of the upper magnetic pole 16 in the vicinity of the floating surface ABS.

In the prior art, as shown in the drawings, the structure in which the respective tip sub-magnetic poles 21 and 22 are formed to be rectangular is only shown. Shapes and arrangement positions of the respective tip sub-magnetic poles, alternatively, performance and characteristic of the thin film magnetic head are not discussed at all.

In the thin film magnetic head with such tip sub-magnetic poles, the tip sub-magnetic poles 21 and 22 are respectively provided on the lower magnetic pole 8 and the upper magnetic pole 16, and the core widths are regulated to be substantially narrow by the respective tip sub-magnetic poles, and thus the recording magnetic field can be generated through the recording gap layer 9 between the tip sub-magnetic poles having the narrow core widths.

The present inventors consider that provision of the tip sub-magnetic poles in the thin film magnetic head is a promising art in the following points (1) and (2), in addition to the above-described advantage.

(1) As an art of narrowing a core width, the provision art is excellent in a point that a precise dimensional accuracy is obtained. However, under the current circumstances, by formation of the pole of the upper magnetic pole utilizing other process technologies, for example, ion milling, an art using a focused ion beam (FIB) or the like, the tip portion of the upper magnetic pole cannot be formed with a dimensional accuracy in the sub-micron order.

(2) According to a desire, a material of the tip sub-magnetic pole can be made different between the upper magnetic pole and the lower magnetic pole. However, in the above-described prior art (in the gazette of Japanese Patent Laid-Open No. 7-225917), with regard to the thin film magnetic head with such a tip sub-magnetic pole, a high frequency characteristic or the like required therefor is not discussed at all.

Herein, a head with a good high frequency characteristic means “a head in which a recording magnetic field applied to a recording medium does not decrease at all even in the case where a magnetic permeability of a head core is lowered with an increase in the frequency”. In other words, in a head which is not good in the high frequency characteristic, when the recording magnetic field decreases with a lowering in the magnetic permeability, an overwrite characteristic of the head is deteriorated.

The overwrite characteristic can be improved to a certain extent by increasing a current flown to the recording coil so as to increase a magnetomotive force. Herein, when the magnetic permeability becomes high (namely,, when a signal of a low frequency is written) in a state where the magnetomotive force is set rather large in accordance with the case where the magnetic permeability of the head core is low, if the recording magnetic filed is increased more than necessary, a recording blur width and a recording demagnetization width (side-erasing width) are increased, thus causing a possibility of affecting a track on the recording medium, which is adjacent to the target track. Accordingly, when the magnetic permeability is sufficiently high (at the time of the low frequency), it is necessary that the intensity of the magnetic field applied to the recording medium be not increased very much.

On the other hand, the present applicant proposed before an art of narrowing a core width by the approach other than the provision of the tip sub-magnetic pole (in Japanese Patent Application No. 10-184780 filed on Jun. 30, 1998, but not laid-open at the time of the filing of the present application nor a publicly known art). FIG. 4A and FIG. 4B are views briefly explaining the proposed art. In the art, as shown in FIG. 4B, trimming with focused ion beam (FIB) is executed for both ends of the pole 16a of the upper magnetic pole 16, thus narrowing the core width thereof. Note that the trimming with the FIB will be simply referred to as “FIB trimming” hereinbelow.

In the proposed art, with regard to the thin film magnetic head in which the core width of the upper magnetic pole is narrowed by the FIB trimming, no discussion on the high frequency characteristic is performed. However, thereafter, the present inventors found out that, when evaluation for the high frequency characteristic was performed with regard to this thin film magnetic head, a good characteristic was obtained as described later in association with FIG. 5.

Therefore, the present inventors performed evaluation for the high frequency characteristic in order to evaluate the thin film magnetic head with the tip sub-magnetic pole, which is conceived to be technically promising. The thin film magnetic head without the tip sub-magnetic pole, which the present applicant proposed before, was set as a subject for comparison (hereinafter, referred to as a “comparative example”).

FIG. 5 shows an evaluation result of the comparative example, and on the other hand, FIG. 6 shows an evaluation result of the thin film magnetic head with the tip sub-magnetic pole, as introduced in the gazette of Japanese Patent Laid-Open No. 7-225917.

With regard to the respective evaluations, there are shown results obtained by performing computer simulation by use of a three-dimensional magnetic field analysis software for a relation between the recording current (magnetomotive force) mmf flown to the recording coil plotted in the abscissa, and the recording magnetic field applied to the recording medium (magnetic field component in the track longitudinal direction) Hx plotted in the ordinate. Note that, as the three-dimensional magnetic field analysis software, a magnetic field analysis software named “MAGIC”, which is commercially available from ELF Corporation located in Japan, is utilized.

First, with reference to the evaluation result of the comparative example shown in FIG. 5, when the magnetomotive force mmf is equal to 0.4 AT, a ratio R (μ300/μ1000) of a recording magnetic field (Δ data) of the magnetic permeability: μ=300 (namely,, at the time of the high frequency) and a recording magnetic field (● data) of the magnetic permeability: μ=1000 (namely,, at the time of the low frequency) becomes as: ratio R (μ300/μ1000)=0.94. On the contrary to this, in the evaluation result of the thin film magnetic head with the tip sub-magnetic pole shown in FIG. 6, the ratio R (μ300/μ1000) becomes as 0.88 under the same condition (magnetomotive force mmf=0.4 AT).

As described above, with regard to the thin film magnetic head, “a head in which the recording magnetic field applied to the recording medium does not decrease at all even in the case where the magnetic permeability of the head core is lowered in an increase in the frequency” is defined to be good. The ratio R (μ300/μ1000) represents a ratio of the recording magnetic field Hx at the time of the high frequency (μ=300) to the recording magnetic field Hx at the time of the low frequency (μ=1000). Accordingly, it is preferable that a value of the ratio R (μ300/μ1000) be larger. Herein, a result was obtained, in which the R (μ300/μ1000) of the comparative example was larger than the R (μ300/μ1000) of the thin film magnetic head with the tip sub-magnetic pole.

Next, in the recording magnetic field characteristic (● data) of the permeability: μ=1000 (at the time of the low frequency) of the comparative example shown in FIG. 5, when a ratio R (0.2 AT/0.4 AT) of the recording magnetic fields Hx at the time of the magnetomotive forces: mmf=0.2 AT and 0.4 AT is obtained, the ratio R (0.2 AT/0.4 AT) becomes as: R (0.2 AT/0.4 AT)=0.88. Contrary to this, in the evaluation result of the thin film magnetic head with the tip sub-magnetic pole shown in FIG. 6, the ratio R (0.2 AT/0.4 AT) becomes as: R (0.2 AT/0.4 AT)=0.805 under the same recording magnetic field characteristic (● data).

As described above, with regard to the magnetic head, when the low frequency appears in a state where the magnetomotive force mmf is set rather large in advance, it is not preferable that the recording magnetic field Hx be increased more than necessary. Accordingly, the ratio R (0.2 AT/0.4 AT) in the magnetic permeability: μ=1000 represents a trailability of a magnetic field fluctuation, which copes with a magnetomotive force fluctuation at the time of the low frequency, and it is preferable that the ratio R (0.2 AT/0.4 AT) be larger. Herein, a result was obtained, in which the R (0.2 AT/0.4 AT) of the comparative example is larger than the R (0.2 AT/0.4 AT) of the thin film magnetic head with the tip sub-magnetic pole.

From the above, with regard to both of the ratio R (μ300/μ1000) and the R (0.2 AT/0.4 AT), it proved that the thin film magnetic head with the tip sub-magnetic pole (FIG. 6) has a magnetic field fluctuation larger in comparison with that of the comparative example (FIG. 5), namely,, the thin film magnetic head in FIG. 6 is in a bad tendency concerning the magnetic head characteristic.

As described above, although the thin film magnetic head with the tip sub-magnetic pole is the promising art, it involves problems such as a lowering of the recording magnetic field accompanied with the lowering of the magnetic permeability and a fluctuation of the recording magnetic field accompanied with the increase of the magnetomotive force. The former problem leads to deterioration of the overwrite characteristic in the high frequency, and the latter problem leads to deterioration of the recording blur characteristic in the low frequency, both of which have room for improvement.

### DISCLOSURE OF THE INVENTION

An object of the present invention is to solve the problems in the above-described prior art, and to provide a novel thin film magnetic head with a tip sub-magnetic pole exhibiting good overwrite and recording blur characteristics, and a method of manufacturing the same.

To achieve the foregoing object, according to one aspect of the present invention, there is provided a thin film magnetic head comprising: a lower magnetic pole; an upper magnetic pole disposed to face the lower magnetic pole; a recording coil disposed between the lower magnetic pole and the upper magnetic pole, the recording coil being spaced from the both magnetic poles; and an upper tip sub-magnetic pole provided at the side of the lower magnetic pole of the upper magnetic pole in the vicinity of a floating surface, in which the upper tip sub-magnetic pole is formed in such a manner that a core width of a body portion thereof is larger than a core width on the floating surface.

Moreover, according to another aspect of the present invention, there is provided a method of manufacturing a thin film magnetic head, comprising the steps of: forming a lower magnetic pole; patterning a first resist in a predetermined shape on the lower magnetic pole so as to form an upper tip sub-magnetic pole spreading a core width thereof in accordance with the shape of the first resist as the upper tip sub-magnetic pole is departing from a floating surface; partially trimming the lower magnetic pole after removing the first resist, so as to form a lower tip sub-magnetic pole; forming an alumina layer on a trimmed portion of the lower magnetic pole and the upper tip sub-magnetic pole; polishing and flattening surfaces of the alumina layer and the upper tip sub-magnetic pole in a film thickness direction; forming a recording coil with a periphery surrounded by non-magnetic insulating layers on the flattened alumina layer; patterning a second resist in a predetermined shape on the flattened upper tip sub-magnetic pole so as to form an upper magnetic pole in accordance with the shape of the second resist; and cutting out a thin film magnetic head from a wafer after removing the second resist, so as to mechanically polish the head to a final finish line.

Furthermore, according to the present invention, there is provided a complex magnetic head comprising: a recording head using the foregoing thin film magnetic head; and a reproducing head using a magnetoresistance effect element as a magnetic transducer, in which the recording head and the reproducing head are integrally formed.

### BRIEF DESCRIPTION OF THE DRAWINGS

FIG. 1 is a perspective view showing a typical complex magnetic head with a portion thereof cut out;

FIG. 2A and FIG. 2B are views for explaining in detail a recording head in the complex magnetic head of FIG. 1;

FIG. 3A and FIG. 3B are views showing a constitution of a prior art thin film magnetic head with a tip sub-magnetic pole;

FIG. 4A and FIG. 4B are views showing a constitution of a thin film magnetic head in which a core width is narrowed by FIB trimming, previously proposed by the present applicant;

FIG. 5 is a graph showing an evaluation result of the thin film magnetic head of FIG. 4A and FIG. 4B;

FIG. 6 is a graph showing an evaluation result of the thin film magnetic head of FIG. 3A and FIG. 3B;

FIG. 7A to FIG. 7C are views showing a constitution of a thin film magnetic head with a tip sub-magnetic pole having a unique shape according to one embodiment of the present invention;

FIG. 8 is a graph showing an evaluation result of a sub-magnetic pole shape parameter “tip projection height SH” with regard to the thin film magnetic head shown in FIG. 7A to FIG. 7C.

FIG. 9 is a graph showing an evaluation result of a sub-magnetic pole shape parameter “spread of a core width of a tip sub-magnetic pole Δ SW” with regard to the thin film magnetic head shown in FIG. 7A to FIG. 7C;

FIG. 10 is a graph showing an evaluation result of a sub-magnetic pole shape parameter “length of a tip sub-magnetic pole SL” with regard to the thin film magnetic head shown in FIG. 7A to FIG. 7C.

FIG. 11 is a graph showing an evaluation result when the sub-magnetic pole shape parameters: “tip projection height SH”; “spread of a tip sub-magnetic pole core width Δ SH”; and “length of a tip sub-magnetic pole SL” are set within desired ranges with regard to the thin film magnetic head shown in FIG. 7A to FIG. 7C;

FIG. 12A to FIG. 12H are a flowchart showing a method of manufacturing the thin film magnetic head shown in FIG. 7A to FIG. 7C in accordance with the order of processes;

FIG. 13A to FIG. 13D are views showing a manufacturing process in the case where trimming by ion milling is performed for a wafer surface;

FIG. 14A to FIG. 14C are views showing a manufacturing process in the case where FIB trimming is performed for the wafer surface;

FIG. 15A and FIG. 15B are views showing a manufacturing process in the case where the trimming by ion milling is performed for a floating surface; and

FIG. 16A and FIG. 16B are views showing a manufacturing process in the case where the FIB trimming is performed for the floating surface.

### BEST MODE FOR CARRYING OUT THE INVENTION

Hereinbelow, description will be made in detail for a thin film magnetic head and a method of manufacturing the same according to the present invention by way of a concrete embodiment with reference to the accompanying drawings. Note that like reference numerals are added to like constituent components throughout the respective drawings, and thus repetition of the description is omitted.

### \mathring{1} Forming of Tip Sub-Magnetic Pole

The present inventors reviewed whether a high frequency characteristic can be improved and whether a recording blur characteristic can be improved, by optimizing a forming position, a shape or the like of a tip sub-magnetic pole of a thin film magnetic head with the tip sub-magnetic pole.

Herein, criterion of the judgment for the presence of an improvement effect will be set as follows, in comparison with the evaluation result of the thin film magnetic head with a tip sub-magnetic pole according to the prior art, which has been described in association with FIG. 6.

(A) When the ratio R (μ300/μ1000) is increased, it shall be judged that there is an improvement effect with regard to the overwrite characteristic.

(B) When the ratio R (0.2 AT/0.4 AT) is increased, it shall be judged that there is an improvement effect with regard to the recording blur characteristic.

(C) When both of the ratio R (μ300/μ1000) and the ratio R (0.2 AT/0.4 AT) are increased, it shall be judged that there are improvement effects with regard to both of the overwrite characteristic and the recording blur characteristic.

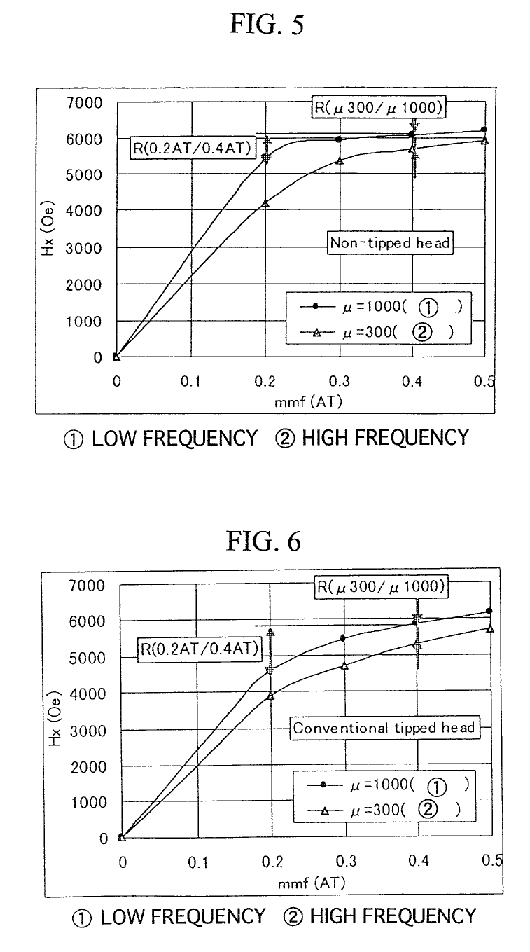

Moreover, when both of the ratio R (μ300/μ1000) and the ratio R (0.2 AT/0.4 AT) are decreased in comparison with the evaluation result of the comparative example (thin film magnetic head without a tip sub-magnetic pole) described in association with FIG. 5, it shall be judged that the final aim is achieved.

Next, the present inventors decided to review the following points (a), (b) and (c) with regard to the forming position and the shape of the tip sub-magnetic pole of the thin film magnetic head with the tip sub-magnetic pole.

(a) Pulling back only the upper magnetic pole a bit from the recording medium, performing surface alignment for the tip sub-magnetic pole with the lower magnetic pole, and forming the tip sub-magnetic pole so as to project a bit from the upper magnetic pole.

(b) As for the tip sub-magnetic pole, setting the core width on the floating surface (ABS) in a desired small dimension, and setting the body portion thereof in a relatively large dimension.

(c) obtaining an optimal value of a thickness of the tip sub-magnetic pole.

Note that, since the lower magnetic pole of the recording head is combined with the upper magnetic shield layer of the reproducing head and has a certain limitation in a shape thereof as described above, heretofore, consideration has been made mainly for the formation of the upper magnetic pole by FIB trimming. Accordingly, also in this embodiment, consideration will be made mainly for the shape or the like of the tip sub-magnetic pole formed on the upper magnetic pole. And, thereafter according to needs, the optimal shape of the tip sub-magnetic pole of the upper magnetic pole will be applied similarly to the lower magnetic pole.

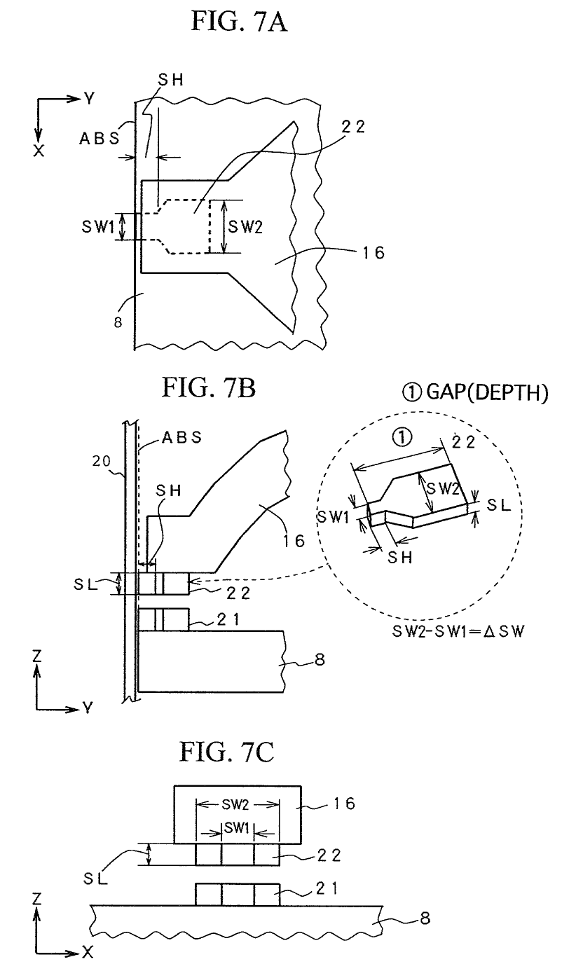

FIG. 7A to FIG. 7C show a constitution of the thin film magnetic head with the tip sub-magnetic pole having a unique shape according to one embodiment of the present invention. Specifically, FIG. 7A shows a plane structure in the vicinity of the magnetic pole tip of the recording head WR in the thin film magnetic head when viewed from the upper surface (wafer surface) of the substrate, FIG. 7B shows a sectional structure in the vicinity of the magnetic pole tip, and FIG. 7C shows the magnetic pole tip portion when viewed from the floating surface ABS. Herein, the floating surface ABS is defined as a magnetic pole tip surface facing the recording medium 20. Moreover, the tip sub-magnetic pole 22 provided additionally in the tip portion of the upper magnetic pole 16 has a plane shape having a substantially constant core width SW1 on the floating surface ABS with a position separate from the tip by several μm as a border and an enlarged core width SW2 at an opposite side thereof (body portion).

Herein, in order to quantitatively specify the forming position and the shape of the tip sub-magnetic pole 22, some shape parameters are selected as follows.

First, as shown in FIG. 7A and FIG. 7B, a position of the upper magnetic pole 16 with no limitation is pulled back a bit relative to the lower magnetic pole 8 with any limitation, thus enabling an effect of the tip sub-magnetic pole 22 on the upper magnetic pole to be exerted to the maximum. However, the tip sub-magnetic pole 22 is formed in such a manner that the main surface thereof faces the surface of the lower magnetic pole 8 and that the core width thereof becomes larger as it is departing from the floating surface ABS. Then, a portion of the tip sub-magnetic pole 22 on the floating surface ABS, where the core width SW1 is constant, namely,, a position where the core width of the tip sub-magnetic pole 22 starts to spread is defined as the “tip projection height SH”. Moreover, as shown in FIG. 7A and FIG. 7C, a difference between the core width SW1 on the floating surface ABS and the core width SW2 of the body portion of the tip sub-magnetic pole 22 is defined as the “spread of a core width of a tip sub-magnetic pole Δ SW”. Furthermore, as shown in FIG. 7B and FIG. 7C, a film thickness of the tip sub-magnetic pole 22 is defined as the “length of a tip sub-magnetic pole SL”.

As described above, in order to specify the forming position and the shape of the tip sub-magnetic pole 22, the SH, Δ SW and SL were selected as the shape parameters.

### \mathring{2} Evaluation for Sub-Magnetic Shape Parameters (SH, Δ SW and SL)

### Evaluation for SH

First, evaluation for the sub-magnetic pole shape parameter “tip projection height SH” was performed. Specifically, under the condition where the other two shape parameters (the spread of a core width of a tip sub-magnetic pole Δ SW and the length of a tip sub-magnetic pole SL) are fixed, the tip projection height SH was changed, and an influence thereby was examined. Note that the fixed shape parameters were set as: Δ SW= 2.0 μm; and SL=1.5 μm.

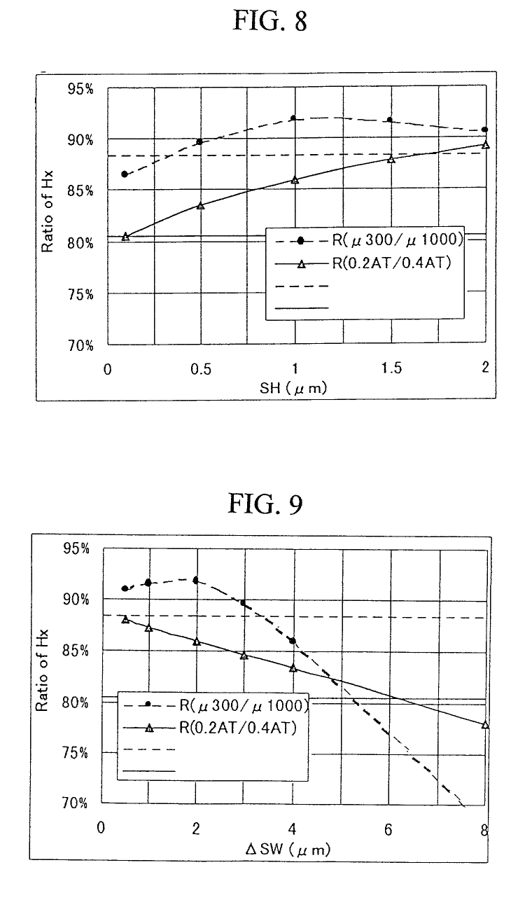

FIG. 8 is a graph showing a change ratio of the magnetic field Hx applied to the recording medium (ordinate) when the tip projection height SH is changed from 0 to 2 μm (abscissa). In the drawing, a dotted line (● data) represents the ratio R (μ300/μ1000) of the recording magnetic field of the magnetic permeability: μ=300 and the recording magnetic field of the magnetic permeability: μ=1000, and a solid line (Δ data) represents the ratio R (0.2 AT/0.4 AT) of the recording magnetic fields in the magnetomotive forces: mmf=0.2 AT; and mmf=0.4 AT.

From the characteristic of the evaluation result in FIG. 8, it was confirmed that, by changing the shape parameter SH, the ratio R (μ300/μ 1000) and the ratio R (0.2 AT/0.4 AT) can be controlled, thus enabling both of the overwrite characteristic and the recording blur characteristic to be improved.

The thin film magnetic head with the tip sub-magnetic pole according to the prior art is set as a criterion of the judgment for the presence of an effect as described in association with FIG. 6, the former ratio is set as: R (μ300/μ1000)=0.88 (represented by the dotted line), and the latter ratio is set as: R (0.2 AT/0.4 AT)=0.805 (represented by the solid line).

When a judgment is made with the conventional thin film magnetic head as a criterion, it proved that data (● dotted line data) of the ratio R (μ300/μ1000) exceeded the reference value: R (μ300/μ1000)=0.88 in a range: SH≧0.3 μm. On the other hand, it proved that data (Δ solid line data) of the ratio R (0.2 AT/0.4 AT) exceeded the reference value: R (0.2 AT/0.4 AT)=0.805 in a range: SH≧0.1 μm.

Accordingly, it is in the range: SH≧0.1 μm that the data of the ratio R (μ300/μ1000) exceed the reference values. In other words, in comparison with the conventional thin film magnetic head, it proved that the overwrite characteristic was improved by setting the tip projection height SH in the range of 0.1 μm to 2.0 μm.

Moreover, it is in the range: SH≧0.3 μm that both of the data of the ratio R (μ300/μ1000) and the data of the ratio R (0.2 AT/0.4 AT) exceed the reference values. Accordingly, it proved that both of the overwrite characteristic and the recording blur characteristic were improved by setting the tip projection height SH in the range of 0.3 μm to 2.0 μm.

### Evaluation for ΔSW

Next, evaluation for the sub-magnetic pole shape parameter “a spread of a core width of a tip sub-magnetic pole ΔSW” was performed. Specifically, under the condition where the other two shape parameters (the tip projection height SH and the length of a tip sub-magnetic pole SL) are fixed, the spread of the core width of the tip sub-magnetic pole was changed, and an influence thereby was examined. Note that the fixed shape parameters were set as: SH=1.0 μm; and SL=1.5 μm.

FIG. 9 is a graph showing a change ratio of the magnetic field Hx applied to the recording medium (ordinate) when the spread of the core width of the tip sub-magnetic pole ΔSW is changed from 0 to 8 μm (abscissa). In the drawing, a dotted line (● data) represents the ratio R (μ300/μ1000), and a solid line (Δ data) represents the ratio R (0.2 AT/0.4 AT).

From the characteristic of the evaluation result in FIG. 9, it was confirmed that, by changing the shape parameter ΔSW, the ratio R (μ300/μ 1000) and the ratio R (0.2 AT/0.4 AT) can be controlled, thus enabling both of the overwrite characteristic and the recording blur characteristic to be improved.

The thin film magnetic head with the tip sub-magnetic pole according to the prior art is similarly set as a criterion of the judgment for the presence of an effect, the former ratio is set as: R (μ300/μ1000)=0.88 (represented by the dotted line), and the latter ratio is set as: R (0.2 AT/0.4 AT)=0.805 (represented by the solid line).

When a judgment is made with the conventional thin film magnetic head as a criterion, it proved that data (● dotted line data) of the ratio R (μ300/μ1000) exceeded the reference value: R (μ300/μ1000)=0.88 in a range: ΔSW≧3.2 μm. On the other hand, it proved that data (Δsolid line data) of the ratio R (0.2 AT/0.4 AT) exceeded the reference value: R (0.2 AT/0.4 AT)=0.805 in a range: ΔSW≧6.2 μm.

Accordingly, it is in the range: ΔSW≧6.2 μm that the data of the ratio R (0.2 AT/0.4 AT) exceed the reference values. In other words, in comparison with the conventional thin film magnetic head, it proved that the recording blur characteristic was improved by setting the spread of a core width of a tip sub-magnetic pole ΔSW in the range of 6.2 μm or less.

Moreover, it is in the range: ΔSW≧3.2 μm that both of the data of the ratio R (μ300/μ1000) and the data of the ratio R (0.2 AT/0.4 AT) exceed the reference values. Accordingly, it proved that both of the overwrite characteristic and the recording blur characteristic were improved by setting the spread of the core width of the tip sub-magnetic pole ΔSW in the range of 3.2 μm or less.

### Evaluation for SL

Furthermore, evaluation for the sub-magnetic pole shape parameter “length of a tip sub-magnetic pole SL” was performed. Specifically, under the condition where the other two shape parameters (the tip projection height SH and the spread of a core width of a tip sub-magnetic pole ΔSW) are fixed, the length of the tip sub-magnetic pole SL was changed, and an influence thereby was examined. Note that the fixed shape parameters were set as: SH=1.0 μm; and ΔSW=2.0 μm.

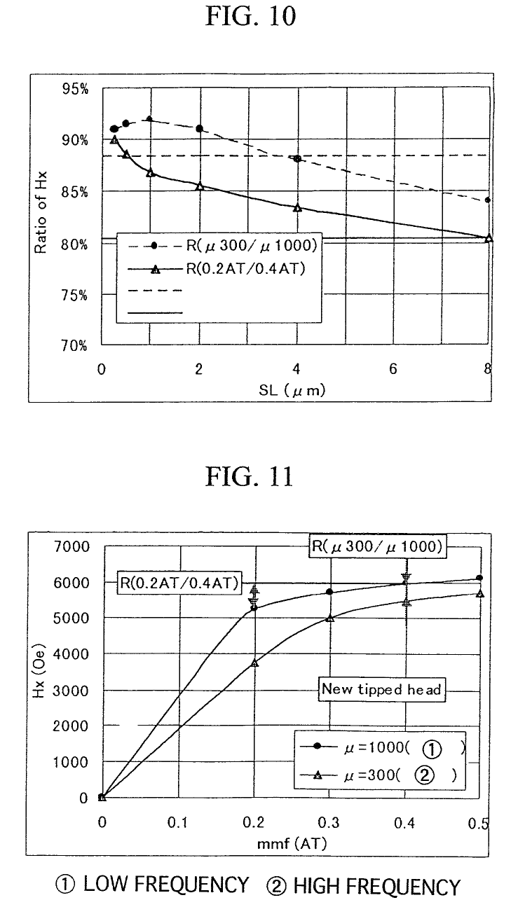

FIG. 10 is a graph showing a change ratio of the magnetic field Hx applied to the recording medium (ordinate) when the length of the tip sub-magnetic pole SL is changed from 0 to 8.0 μm (abscissa). In the drawing, a dotted line (● data) represents the ratio R (μ300/μ1000), and a solid line (Δ data) represents the ratio R (0.2 AT/0.4 AT).

From the characteristic of the evaluation result in FIG. 10, it was confirmed that, by changing the shape parameter SL, the ratio R (μ300/μ 1000) and the ratio R (0.2 AT/0.4 AT) can be controlled, thus enabling both of the overwrite characteristic and the recording blur characteristic to be improved.

The thin film magnetic head with the tip sub-magnetic pole according to the prior art is similarly set as a criterion of the judgment for the presence of an effect, the former ratio is set as: R (μ300/μ1000) =0.88 (represented by the dotted line), and the latter ratio is set as: R (0.2 AT/0.4 AT)=0.805 (represented by the solid line).

When a judgment is made with the conventional thin film magnetic head as a criterion, it proved that data (● dotted line data) of the ratio R (μ300/μ1000) exceeded the reference value: R (μ300/μ1000)=0.88 in a range: SL≦3.6 μm. On the other hand, it proved that data (Δ solid line data) of the ratio R (0.2 AT/0.4 AT) exceeded the reference value: R (0.2 AT/0.4 AT)=0.805 in a range: SH≦8.0 μm.

Accordingly, it is in the range: 0<SL≦8.0 μm that the data of the ratio R (0.2 AT/0.4 AT) exceed the reference values. In other words, in comparison with the conventional thin film magnetic head, it proved that the recording blur characteristic was improved by setting the length of the tip sub-magnetic pole SL in the range of 8.0 μm or less.

Moreover, it is in the range: 0<SL≦3.6 μm that both of the data of the ratio R (μ300/μ1000) and the data of the ratio R (0.2 AT/0.4 AT) exceed the reference values. Accordingly, it proved that both of the overwrite characteristic and the recording blur characteristic were improved by setting the length of the tip sub-magnetic pole SL in the range of 3.6 μm or less.

From the above, the ranges of the respective shape parameters of the tip sub-magnetic pole were decided as follows.

SH: 0.1 μm≦SH≦2.0 μm, desirably 0.3 μm≦SH≦2.0 μm

ΔSW: 0<ΔSW≦6.2 μm, desirably 0<ΔSW≦3.2 μm

SL: 0<SL≦8.0 μm, desirably 0<SL≦3.6 μm

As described above, with regard to the parameters (SL, SH and ΔSW) for specifying the forming position and the shape of the tip sub-magnetic pole, the ranges exceeding the characteristics of the conventional thin film magnetic head (see FIG. 6) were decided.

### \mathring{3} Best Tip Sub-Magnetic Pole Shape

At the next stage, evaluation was performed for the thin film magnetic head with the tip sub-magnetic pole satisfying all of the ranges where both of the data of the ratio R (μ300/μ1000) and the data of the ratio R (0.2 AT/0.4 AT) were defined to exceed the reference values with regard to the shape parameters SH, ΔSW and SL (above-described ranges shown with “desirably”). Note that the respective shape parameters are:

SH=1.0 μm; ΔSW=2.0 μm; and SL=1.5 μm.

FIG. 11 shows an evaluation result with regard to the thin film magnetic head according to this embodiment when the respective parameters SH, ΔSW and SL are set within the desired ranges. In the drawing, the abscissa represents the magnetomotive force mmf, and the ordinate represents the recording magnetic field Hx. Also the dotted line (● data) represents the ratio R (μ300/μ1000), and the solid line (▴ data) represents the ratio R (0.2 AT/0.4 AT).

As for the criterion of the judgment for the presence of an effect, the thin film magnetic head is formed within the range satisfying the reference values described above in association with FIG. 6, namely,, R (μ300μ 1000)=0.88, and R (0.2 AT/0.4 AT)=0.805 of the conventional thin film head. Accordingly, comparison was made with the comparative example described as an aim in association with FIG. 5 (thin film magnetic head without the tip sub-magnetic pole). In the comparative example, R (μ300/μ 1000)=0.94, and R (0.2 AT/0.4 AT)=0.88.

Contrary to this, in the thin film magnetic head with the tip sub-magnetic pole satisfying all of the ranges of the shape parameters SH, ΔSW and SL shown in FIG. 11, R (μ300/μ1000)=0.92, and R (0.2 AT/0.4 AT)=0.86. Consequently, in the evaluation result shown in FIG. 11, it proved that the magnetic field fluctuation in any of the ratio R (μ300/μ 1000) and the ratio R (0.2 AT/0.4 AT) was small in comparison with that of the comparative example. Specifically, it proved that both of the overwrite characteristic and the recording blur characteristic were improved.

### \mathring{4} Manufacturing Method

### Thin Film Magnetic Head with a Tip Sub-Magnetic Pole

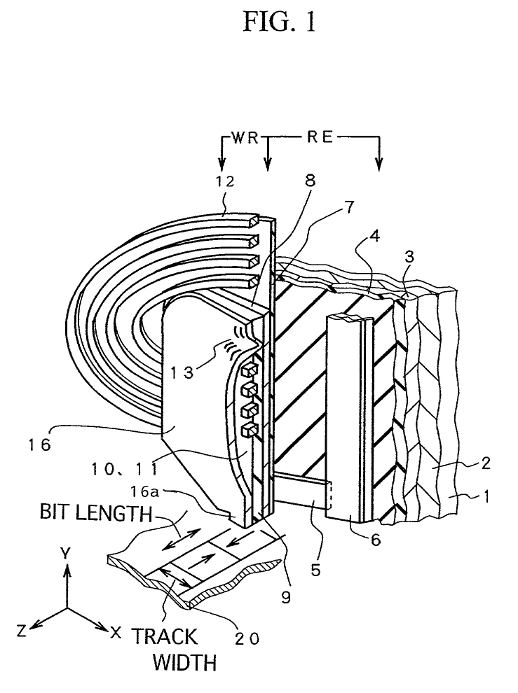

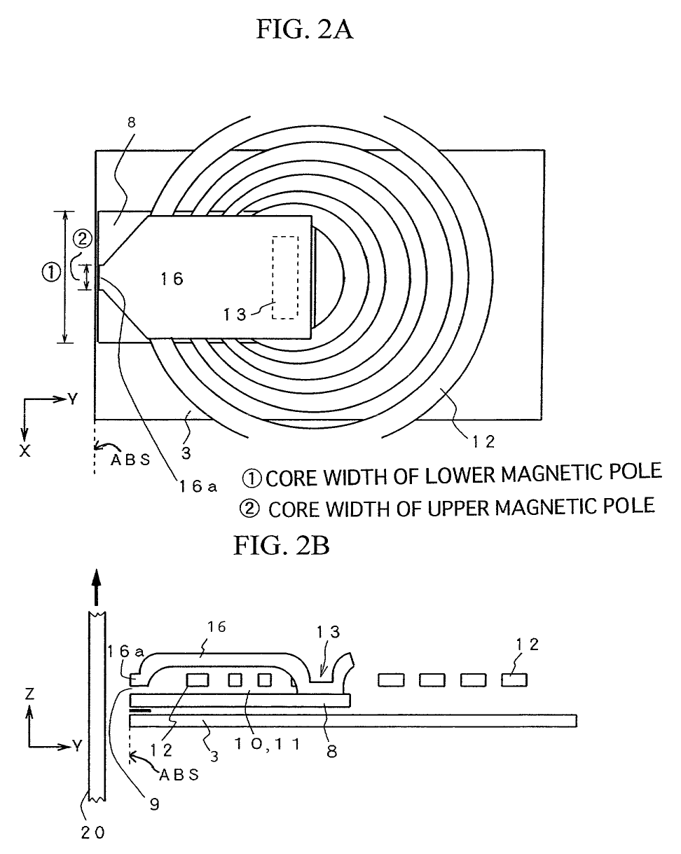

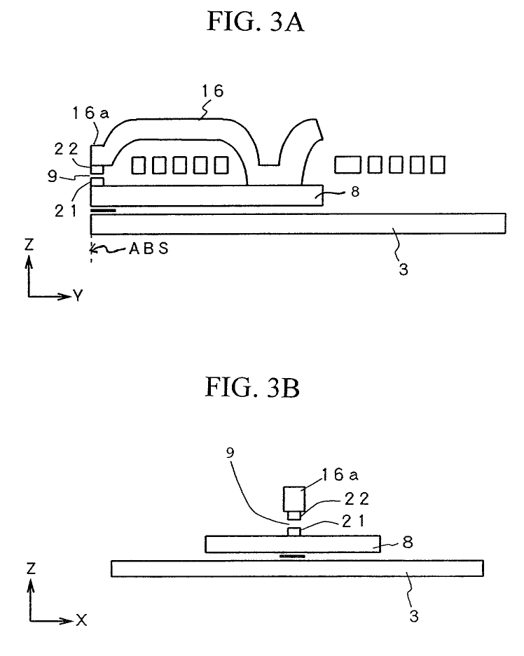

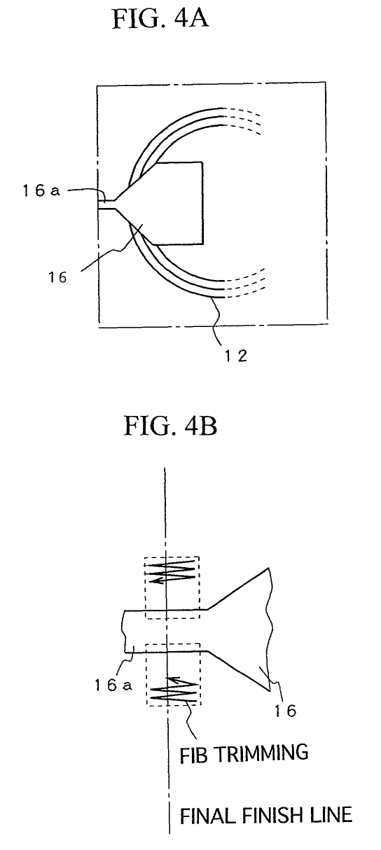

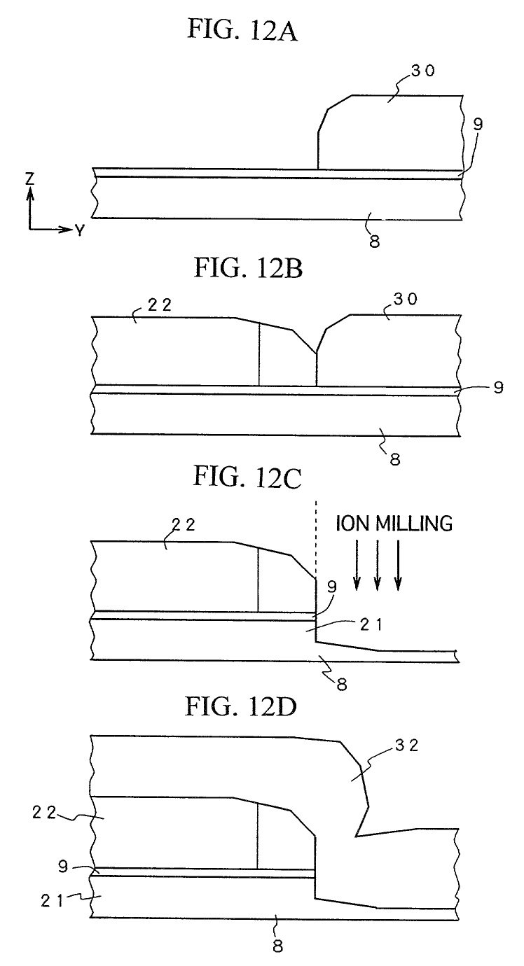

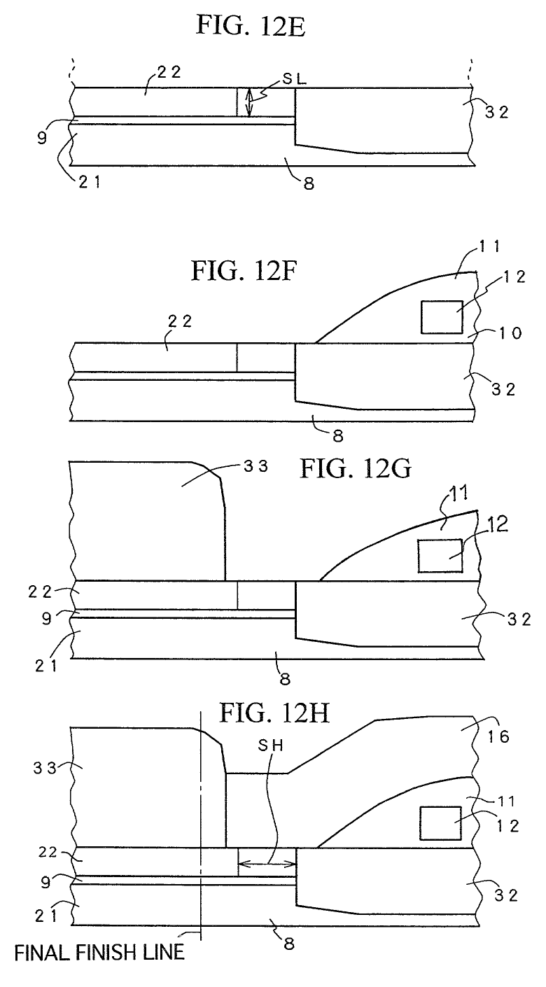

FIG. 12A to FIG. 12H are views showing a method of manufacturing a thin film magnetic head with the tip sub-magnetic pole according to this embodiment in accordance with the order of processes. These drawings correspond to FIG. 7B, and are side views of the substrate (wafer) in the manufacturing process of the tip sub-magnetic pole. Note that description will be made on the assumption that the reproducing head (RE) described in association with FIG. 1 has been already formed.

First, in the first step (see FIG. 12A), on the second non-magnetic insulating layer 7 (see FIG. 1) of the reproducing head RE, the lower magnetic pole 8 of the recording head WR, which is combined with the lower magnetic shield layer 8, is formed. The lower magnetic pole 8 typically consists of an NiFe-series alloy or a Co-series alloy, and for example, may be Ni(50)Fe(50), Ni(80)Fe(20), CoNiFe, FeZrN or the like. In advance, a plating base layer (not shown) is formed by a sputtering method or an evaporation method, and next, the lower magnetic pole 8 having a thickness of about several μm is formed by electrolytic plating. In the case where the lower magnetic pole 8 is deposited by the sputtering method, an Fe-series alloy or a Co-series alloy (CoZr or the like) is used. In this case, the plating base layer is not required.

Next, the recording gap layer 9 is formed on the lower magnetic pole 8. The recording gap layer 9 consists of, for example Al₂O₃, SiO₂ or the like. In order to prevent the film thickness of the recording gap layer from being reduced in a later etching step, a protective layer (not shown) may be provided on the recording gap layer according to needs.

Next, on the recording gap layer 9, for example, a photosensitive photoresist 30 is coated by a spin coat method, and the resist 30 is patterned into a shape in accordance with the shape of the tip sub-magnetic pole formed in a later step. At this time, one of the shape parameters of the tip sub-magnetic pole “spread of a core width of a tip sub-magnetic pole ΔSW” is defined.

In the next step (see FIG. 12B), the upper tip sub-magnetic pole 22 is formed with the resist 30 as a mask. Typically, the upper tip sub-magnetic pole 22 may be formed of the same material as that of the lower magnetic pole 8. In advance, a plating base layer (not shown) is formed by a sputtering method or an evaporation method, and next, the lower magnetic pole 8 is formed by electrolytic plating. In the case where the upper tip sub-magnetic pole 22 is deposited by the sputtering method, the Fe-series alloy or the Co-series alloy (CoZr or the like) is used. In this case, the plating base layer is not required. After forming the upper tip sub-magnetic pole 22, the resist 30 is removed.

In the next step (see FIG. 12C), one end of the upper tip sub-magnetic pole 22 is regulated based on a gap depth (see FIG. 7B), and the recording gap layer 9 and the lower magnetic pole 8 in a region other than a portion where the tip sub-magnetic pole 22 is formed are trimmed by ion milling. Thus, a portion remaining in a projection shape in the lower magnetic pole 8 constitutes the lower tip sub-magnetic pole 21.

In the next step (see FIG. 12D), an alumina layer 32 is formed so as to cover the upper tip sub-magnetic pole 22 and the exposed lower magnetic pole 8.

In the next step (see FIG. 12E), the surfaces of the alumina layer 32 and the upper tip sub-magnetic pole 22 are polished by lapping, polishing or the like, and are flattened. The purpose of performing such flattening is to secure the position alignment accuracy at the time of coating of a resist in a later step by eliminating unevennesses on the substrate, and thus to achieve the accuracy improvement in patterning the upper magnetic pole or the like. At this step, one of the shape parameters of the tip sub-magnetic pole “length of a tip sub-magnetic pole SL” is defined.

In the next step (see FIG. 12F), on the alumina layer 32, the recording coil 12 surrounded by the non-magnetic insulating layers 10 and 11 is formed. This step will be briefly described because it is not directly associated with the present invention. First, a photoresist is coated, appropriately patterned, and thermally set, thus forming the insulating layer 10 under the recording coil 12. Thereafter, the spiral recording coil 12 is formed, and further, through the coating of a photoresist, patterning, thermosetting or the like, the insulating layer 11 is formed around and on the recording coil 12. At this time, a portion corresponding to the center region of the spiral recording coil 12 (portion shown by reference numeral 13 in FIG. 1) is removed, thus forming a hole. This hole is used for connecting the upper magnetic pole 16 with the lower magnetic pole 8 therethrough when the upper magnetic pole 16 is formed in a later step.

In the next step (see FIG. 12G), a plating base layer (not shown) is formed on the upper tip sub-magnetic pole 22 and the non-magnetic insulating layer 11, and further, a photosensitive photoresist 33 is coated by a spin coating method, and the resist 33 is patterned into a shape in accordance with the shape of the upper magnetic pole to be formed in a later step.

In the final step (see FIG. 12H), the upper magnetic pole 16 is formed to have a thickness of several μm by electrical plating on the non-magnetic insulating layer 11 and the upper tip sub-magnetic pole 22 with the resist 33 as a mask. Further, after removing the resist 33, the exposed plating base layer other than that under the upper magnetic pole 16 is removed by ion milling. Thereafter, electrode pads (not shown) connected to terminals at both ends of the magnetic transducer 5 and electrode pads (not shown) of the recording coil 12 are formed.

Finally, the individual magnetic heads are cut out from the wafer where the plurality of magnetic heads are simultaneously formed, and the respective magnetic heads are mechanically polished from the floating surface ABS to the final finish line. The final finish line is determined by the gap depth (see FIG. 7B), and at this step, one of the shape parameters of the tip sub-magnetic pole “tip projection height SH” is defined.

By the steps of FIG. 12A to FIG. 12H described above, the thin film magnetic head with the tip sub-magnetic pole having the unique shape according to this embodiment can be manufactured.

### Additional Manufacturing Method of Upper Magnetic Pole Itself

For the thin film magnetic head manufactured by the steps of FIG. 12A to FIG. 12H, the pole 16a of the upper magnetic pole 16 is trimmed to be formed in a desired shape according to needs in such a manner as the present applicant previously proposed (in Japanese Patent Application No. 10-184780), thus enabling a further improvement in the characteristic to be achieved.

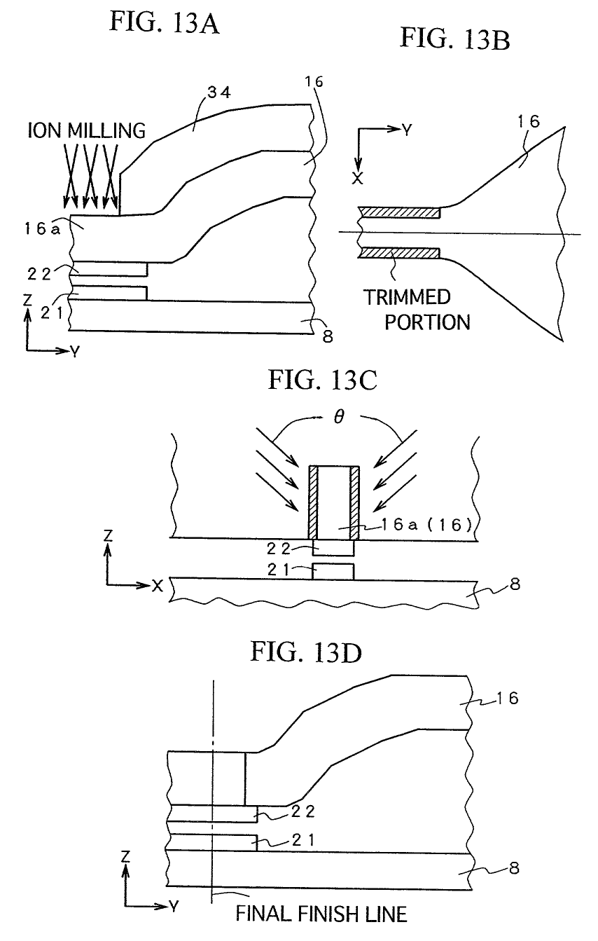

FIG. 13A to FIG. 13D show a manufacturing process in the case where trimming by ion milling is performed for the wafer surface. First, as shown in FIG. 13A and FIG. 13B, after forming up to the upper magnetic pole 16 on the substrate (wafer), the protective film 34 or a protective resist patterned so as to open an window only in the vicinity of a trailing edge of the upper magnetic pole 16 is coated and trimmed by ion milling. As shown in FIG. 13C, the ion milling is one in which the wafer is rocked at a specified angle (θ) while rotating it, and is subjected to a polishing processing from the floating surface side. By this method, the side surfaces of the upper magnetic pole 16 can be polished to a desired extent without scraping the upper surface thereof so much. Then, as shown in FIG. 13D, after removing the protective film 34, the individual thin film magnetic heads are cut out from the wafer, and are subjected to the polishing processing from the floating surface to the final finish line.

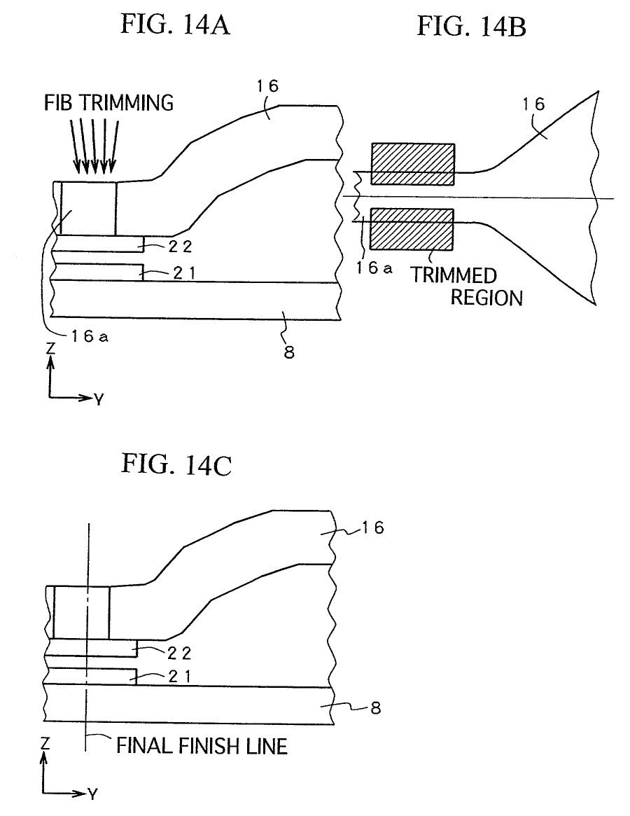

FIG. 14A to FIG. 14C show a manufacturing process in the case where the FIB trimming is performed for the wafer surface. First, as shown in FIG. 14A and FIG. 14B, after forming up to the upper magnetic pole 16 on the substrate (wafer), the trimming by the focused ion beam (FIB) focused on the vicinity of the trailing edge of the upper magnetic pole 16 is performed. Then, as shown in FIG. 14C, the individual thin film magnetic heads are cut out from the wafer, and are subjected to the polishing processing from the floating surface to the final finish line.

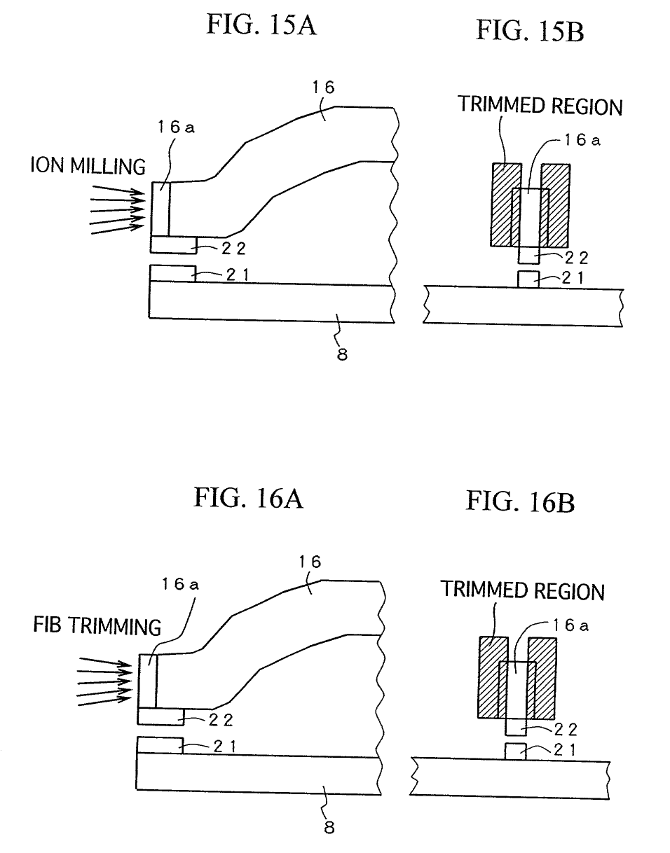

FIG. 15A and FIG. 15B show a manufacturing process in the case where the trimming by ion milling is performed for the floating surface. As shown in the drawings, after cutting out each magnetic head from the wafer and performing the polishing processing therefor from the floating surface (namely,, after performing a slider processing therefor), on the floating surface, a protective film or the like (not shown) patterned so as to open an window only in the vicinity of a side edge of the upper magnetic pole 16 is coated and trimmed by ion milling.

FIG. 16A and FIG. 16B show a manufacturing process in the case where the FIB trimming is performed for the floating surface. As shown in the drawings, after cutting out each magnetic head from the wafer and performing the polishing processing therefor from the floating surface (namely,, after performing the slider processing therefor), the trimming by the FIB focused on the side edge portion of the upper magnetic pole 16 on the floating surface is performed.

As described above, according to the thin film magnetic head and the method of manufacturing the same according to the present embodiment, in the complex magnetic head with the tip sub-magnetic pole or in the inductive recording/reproducing thin film head, it is possible to solve the problems including a lowering of the recording magnetic field accompanied with a lowering of the magnetic permeability causing deterioration of the high frequency overwrite characteristic and an increase of the recording magnetic filed accompanied with an increase of the magnetomotive force causing deterioration of the low frequency recording blur characteristic. Thus, it is possible to fabricate the thin film magnetic head having a good high frequency characteristic and a recording blur characteristic, and the regulation of the track width and the reduction of the recording blur, which have been the original purposes of the thin film magnetic head with the tip sub-magnetic pole, can be achieved, and thus it is possible to realize a high recording densification.

1. A thin film magnetic head comprising:
a lower magnetic pole (8);
an upper magnetic pole (16) disposed to face said lower magnetic pole;
a recording coil (12) disposed between said lower magnetic pole and said upper magnetic pole, the recording coil being spaced from said both magnetic poles; and
an upper tip sub-magnetic pole (22) provided at the side of said lower magnetic pole of said upper magnetic pole, in the vicinity of a floating surface,
said upper tip sub-magnetic pole being formed in such a manner that a core width (SW2) of a body portion thereof is larger than a core width (SW1) at said floating surface (ABS).

2. The thin film magnetic head according to claim 1, wherein, when a position where the core width of said tip sub-magnetic pole starts to spread is defined as a tip projection height (SH) from said floating surface, said tip projection height is selected to be a value at which at least one of an overwrite characteristic and a recording blur characteristic is improved.

3. The thin film magnetic head according to claim 2, wherein said tip projection height is selected to be 0.1 μm or more.

4. The thin film magnetic head according to claim 3, wherein said tip projection height is selected to be 0.3 μm or more.

5. The thin film magnetic head according to claim 1, wherein, when a difference between the core width of said body portion and the core width at said floating surface is defined as a spread (Δ SW) of a core width of a tip sub-magnetic pole, said spread of the core width is selected to be a value at which at least one of an overwrite characteristic and a recording blur characteristic is improved.

6. The thin film magnetic head according to claim 5, wherein the spread of said core width is selected to be 6.2 μm or less.

7. The thin film magnetic head according to claim 6, wherein the spread of said core width is selected to be 3.2 μm or less.

8. The thin film magnetic head according to claim 1, wherein, when a film thickness of said upper tip sub-magnetic pole is defined as a length (SL) of a tip sub-magnetic pole, the length of said tip sub-magnetic pole is selected to be a value at which at least one of an overwrite characteristic and a recording blur characteristic is improved.

9. The thin film magnetic head according to claim 8, wherein the length of said tip sub-magnetic pole is selected to be 8.0 μm or less.

10. The thin film magnetic head according to claim 9, wherein the length of said tip sub-magnetic pole is selected to be 3.6 μm or less.

11. The thin film magnetic head according to claim 1, wherein, when a position where the core width of said tip sub-magnetic pole starts to spread is defined as a tip projection height (SH) from said floating surface, the tip projection height is selected to be 0.3 μm or more; when a difference between the core width of said body portion and the core width on said floating surface is defined as a spread (Δ SW) of a core width of a tip sub-magnetic pole, the spread of the core width is selected to be 3.2 μm or less; and when a film thickness of said upper tip sub-magnetic pole is defined as a length (SL) of a tip sub-magnetic pole, the length of the tip sub-magnetic pole is selected to be 3.6 μm or less.

12. The thin film magnetic head according to claim 1, further comprising a lower tip sub-magnetic pole (21) provided at the side of said upper magnetic pole of said lower magnetic pole in the vicinity of the floating surface, the lower tip sub-magnetic pole having the same shape as that of said upper tip sub-magnetic pole.

13. A complex magnetic head, comprising:
a recording head using the thin film magnetic head according to claim 1; and
a reproducing head using a magnetoresistance effect element as a magnetic transducer,
said recording head and said reproducing head being integrally formed.

14. A method of manufacturing a thin film magnetic head, comprising the steps of
(a) forming a lower magnetic pole (8);
(b) patterning a first resist (30) in a predetermined shape on said lower magnetic pole so as to form an upper tip sub-magnetic pole (22) spreading a core width thereof in accordance with the shape of the first resist as the upper tip sub-magnetic pole is departing from a floating surface;
(c) partially trimming said lower magnetic pole, after removing said first resist, so as to form a lower tip sub-magnetic pole (21);
(d) forming an alumina layer (32) on a trimmed portion of said lower magnetic pole and said upper tip sub-magnetic pole;
(e) polishing and flattening surfaces of said alumina layer and said upper tip sub-magnetic pole in a film thickness direction;
(f) forming a recording coil (12) with a periphery surrounded by non-magnetic insulating layers (10, 11) on said flattened alumina layer;
(g) patterning a second resist (33) in a predetermined shape on said flattened upper tip sub-magnetic pole so as to form an upper magnetic pole (16) in accordance with the shape of the second resist; and
(h) cutting out a thin film magnetic head from a wafer, after removing said second resist, so as to mechanically polish the head to a final finish line.

15. The method according to claim 14, further comprising the step of forming a recording gap layer (9) on said lower magnetic pole after said step (a), wherein said first resist is coated on the formed recording gap layer.

16. The method according to claim 14, wherein said step (c) includes a step of partially trimming said lower magnetic pole by ion milling.

17. The method according to claim 14, further comprising the steps of: coating a protective film on a region other than a vicinity region that will be the floating surface of said upper magnetic pole, so as to pattern the film in a predetermined shape; and trimming the wafer surface by ion milling, after said step (h).

18. The method according to claim 14, further comprising the step of trimming the wafer surface by a focused ion beam, between said step (g) and said step (h).

19. The method according to claim 14, further comprising the steps of: coating a protective film on a region other than a vicinity region that will be the floating surface of said upper magnetic pole, so as to pattern the film in a predetermined shape; and trimming said floating surface by ion milling, after said step (h).

20. The method according to claim 14, further comprising the step of trimming the floating surface of said upper magnetic pole by a focused ion beam after said step (h).

21. The method according to claim 14, wherein, in said step (b), a difference between a core width (SW2) of a body portion of said upper tip sub-magnetic pole and a core width (SW1) at said floating surface is defined as a spread (ΔSW) of a core width of a tip sub-magnetic pole.

22. The method according to claim 14, wherein, in said step(e), a film thickness of said upper tip sub-magnetic pole is defined as a length (SL) of a tip sub-magnetic pole.

23. The method according to claim 14, wherein, in said step (h), a position where a core width of said upper sub-magnetic pole starts to spread is defined as a tip projection height (SH) from said floating surface.
